(19) United States
(12) Patent Application Publication
(10) Pub. No.: US 2020/0079103 A1
(43) Pub. Date: Mar. 12, 2020

(54) BASE COLORANT FLUIDS AND AUXILIARY COLORANT FLUIDS

(71) Applicant: Hewlett-Packard Development Company, L.P., Spring, TX (US)

(72) Inventors: Alex Andrea Tallada, Barcelona (ES); Barret Kammerzell, Vancouver, WA (US)

(21) Appl. No.: 16/469,584

(22) PCT Filed: Mar. 17, 2017
(86) PCT No.: PCT/US2017/023031

§ 371 Date: Jun. 13, 2019

(51) Int. Cl. B41J 2/21

(52) U.S. Cl. CPC B41J 2/2103

(57) ABSTRACT

In one implementation, an example print apparatus includes a fluid ejection system operated by control instructions generated from a print engine and a compensation engine. The compensation engine determines an amount of the auxiliary colorant fluid to produce a combination of the base colorant fluid and the auxiliary colorant fluid based on input color image data, a reflective quality of a substrate to be printed on, and an opacity grade of the base colorant fluid. The print engine generates control instructions to instruct the fluid ejection system to print the combination of the base colorant fluid and the auxiliary colorant fluid on the substrate.

### BACKGROUND

Images are processed for use with computing machines, such as a print apparatus. A print apparatus, for example, may use control data based on processed image data to reproduce a physical representation of an image by operating a print fluid ejection system according to the control data. Image processing may include color calibration within a color space, such as red, green, blue (RGB) color space; cyan, magenta, yellow, black (CMYK) space; or other variations such as the use of additional colors include white or lighter versions of cyan, magenta, or yellow. An image may be processed in a print apparatus pipeline or processed offline in separate compute device, such as a print server.

### BRIEF DESCRIPTION OF THE DRAWINGS

FIGS. 1-3 are block diagrams depicting example print systems.

FIGS. 4-7 depicts example representations of printed material resulting from example print systems.

FIG. 8 depicts example modules used to implement an example print system.

FIGS. 9-11 are flow diagrams depicting example methods of color balancing.

### DETAILED DESCRIPTION

In the following description and figures, some example implementations of print apparatus, print systems, and/or methods of color balancing are described. In examples described herein, a “print apparatus” may be a device to print content on a physical medium (e.g., paper or a layer of powder-based build material, etc.) with a print fluid (e.g., ink or toner). For example, the print apparatus may be a wide-format print apparatus that prints latex-based print fluid on a print medium, such as a print medium that is size A2 or larger. In the case of printing on a layer of powder-based build material, the print apparatus may utilize the deposition of print fluids in a layer-wise additive manufacturing process. A print apparatus may utilize suitable print consumables, such as ink, toner, fluids or powders, or other raw materials for printing. In some examples, a print apparatus may be a three-dimensional (3D) print apparatus. An example of print fluid is a water-based latex ink ejectable from a print head, such as a piezoelectric print head or a thermal inkjet print head. Other examples of print fluid may include dye-based color inks, pigment-based inks, solvents, gloss enhancers, fixer agents, and the like.

Certain examples described herein relate to color calibration of a print system. For example, color calibration may be used to adjust the color response of the print system to more accurately correspond to a desired color to be printed. Color calibration may be used to calibrate a color mapping process by which a first representation of a given color is mapped to a second representation of the same color. The concept of “color” can be represented in a large variety of ways, such as in relation to a power or intensity spectrum of electromagnetic radiation across a range of visible wavelengths or a color model is used to represent a color at a lower dimensionality. A “color” may be said to be a category that is used to denote similar visual perceptions where two colors are said to be similar if they produce a similar effect on a group of one or more people. These categories can then be modelled using a lower number of variables. In an example printing pipeline, individual inks may be calibrated separately so that printed colors are similar to or match desired colors.

A color model may define a color space, i.e., a multi-dimensional space with dimensions of the space representing variables within the color model and a point in the multi-dimensional space representing a color value. For example, in a red, green, blue (RGB) color space, an additive color model defines three variables representing different quantities of red, green and blue light. Another color space includes a cyan, magenta, yellow and black (CMYK) color space, in which four variables are used in a subtractive color model to represent different quantities of colorant or ink, e.g., for a print system and an image with a range of different colors can be printed by overprinting images for each of the colorants or inks. Yet other examples include: the International Commission on Illumination (CIE) 1931 XYZ color space, in which three variables (‘X’, ‘Y’ and ‘Z’ or tristimulus values) are used to model a color; the CIE 1976 (L*, a*, b*—CIELAB or ‘LAB’) color space, in which three variables represent lightness (‘L’) and opposing color dimensions (‘a’ and ‘b’); and the Yu‘v’ color space, in which three variables represent the luminance (‘Y’) and two chrominance dimensions (u′ and v′). Other spaces include area coverage spaces, such as the Neugebauer Primary area coverage (NPac) space, which may be used as a print control space that controls a color output of an imaging device. An NPac space may provide a number of metamers. Metamerism is the existence of a multitude of combinations of reflectance and emission properties that result in the same perceived color for a fixed illuminant and observer.

Perceived color may be affected by any number of factors and a change in any of those factors may result in a change of what color is perceived. For example, a print may look different if it is printed on white paper or black paper. For another example, a print may look different if it is illuminated with a cool white bulb or a soft white bulb.

Various examples described below relate to color balancing based on the opacity of a target print fluid (discussed herein as “a base colorant fluid”) used to produce a print of image data. The color may be balanced to match the desired target color by calibrating the print to compensate for factors that affect perceived color, such as substrate attributes. In this manner, a user of a print apparatus may have the ability to control the hues or “temperatures” of colors at the time of printing to an expected circumstance, for example, and compensate for any color perception affects provided by the expected circumstance, such as viewing environment, substrate attributes, and print fluid manufacturing process.

The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus.

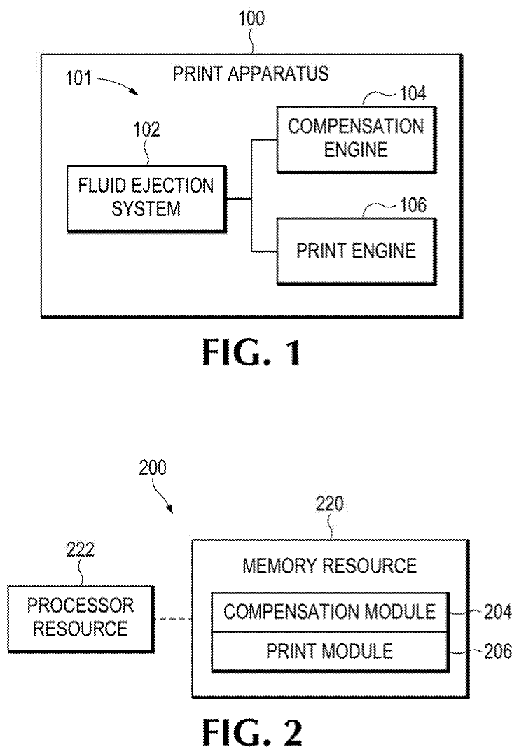

FIGS. 1-3 are block diagrams depicting example print systems. Referring to FIG. 1, the example print apparatus 100 of FIG. 1 has a print system 101 that generally includes a fluid ejection system 102, a compensation engine 104, and a print engine 106. In general, the print engine 106 provides instruction to operate the fluid ejection system 102 based on the amount of fluids determined by the compensation engine 104.

The fluid ejection system 102 represents any hardware components capable of ejecting fluid from a supply onto a print medium. Example fluid ejection systems include a piezoelectric print head or a thermal inkjet print head. The fluid ejection systems discussed herein include systems capable of being coupled to multiple supplies of print fluid and capable of ejecting from the coupled supplies (i.e., eject multiple types of print fluid). In particular, the print apparatus 100 has a fluid ejection system 102 capable of being operated to eject a plurality of colorant fluids. For example, the fluid ejection system 102 may include a first print head to print a base colorant fluid and a second print head to print an auxiliary colorant fluid.

The compensation engine 104 represents any circuitry or combination of circuitry and executable instructions to determine an amount of an auxiliary colorant fluid to print to produce a colorant fluid combination that represents a target color based on input color image data, a reflective quality of a substrate to be printed on, and an opacity grade of the base colorant fluid. The colorant fluid combination is produced by ejecting an amount of auxiliary colorant fluid to a substrate region with an amount of base colorant where the amounts of auxiliary and based colorant fluids are to produce a target color at the region. The compensation engine 104 may be, for example, a combination of circuitry and executable instructions that determine an amount of auxiliary colorant fluid to eject in proportion to an effect of a reflective quality of the substrate on an amount of base colorant fluid based on the opacity grade of the base colorant fluid. In that example, the compensation engine 104 uses the reflective quality of the substrate to identify which type of auxiliary colorant fluid to select and the opacity grade of base colorant ink and reflective quality of the substrate to determine an amount of color balancing to compensate for at a region of the substrate, and then identifies an amount of auxiliary colorant fluid corresponding to the determined amount of color balancing to deposit at the region. The compensation engine 104 may take into consideration any number of factors that affect the color temperature of a target color, where factors may be determined by analysis, retrieved from a data store, and/or requested as input through a user interface, including personal taste for perception of the particular color within the resultant print. For example, the print apparatus 100 may include a user interface including a preview window for displaying a target output color and a slider that allows a user to move the slider to adjust color balancing until a desired color hue is obtained, where any adjustments are captured by operations of the compensation engine 104. In that example, the slider may adjust the amount of auxiliary colorant fluid to print with the combination of base colorant fluid and auxiliary print fluid to produce the output color.

As used herein, a reflective quality of a substrate represents any attribute of the substrate that may affect how color is perceived on the substrate. Example attributes include a color characteristic of a substrate (e.g., the background color of the print), a class of finish of the substrate surface, a degree of porosity of the substrate, a degree of transparency of the substrate, a treatment applied to a substrate, and the like or any combination thereof. Other example attributes that affect the reflective quality of the substrate may be specific to a particular job for which the substrate is used or particular to customer expectations, such as an expected viewing side of the substrate (i.e., the side of the substrate from which the print is expected to be viewed), an expected illumination side of the substrate (i.e., the side of the substrate expected to be illuminated when the print is expected to be viewed), an amount of illumination expected to be place on the print, a color of illumination expected to be placed on the print, and the like or any combination thereof. The compensation engine 104 may retrieve or otherwise determine any number of the factors discussed herein to determine the reflective quality of substrate and make corresponding adjustments. For example, the compensation engine 104 may determine an amount of auxiliary color fluid for a region based on an expected viewing side of a resultant print on the substrate and an expected illuminated side of the resultant print on the substrate.

An opacity grade, as used herein, represents a degree of opacity. For example, the opacity grade of a base colorant fluid for a white ink is a degree of transparency of light through the white ink. Factors may contribute to the degree of opacity of the opacity grade, such as the manufacturing process, the concentration of pigment of the base colorant fluid, the age of the base colorant fluid, the type of fluid (e.g., water-based or latex-based fluid), and the like or any combination thereof. For example, if the opacity grade of the base colorant fluid allows for the substrate to affect the hue of the amount of base colorant fluid, then the compensation engine 104 may determine an amount of auxiliary colorant fluid to eject in the same region as the amount of base colorant to compensate for the perceived offset due to the reflective quality of the substrate as perceived through the base colorant fluid at the region. For another example, the compensation engine 104 may determine an output color represented by the amount of auxiliary colorant fluid and a complementary amount of base colorant fluid to compensate for the reflective quality of the substrate as perceived across a region of the substrate through the complementary amount of base colorant fluid. The compensation engine 104 may determine to place different amounts of auxiliary colorant fluid across a variety of regions to receive the base colorant fluid based on the degree of effect that the reflective quality has on the different amounts of base colorant fluid at the regions (e.g., based on the opacity grade of the base colorant fluid and the amount of the base colorant fluid at each region). For example, the compensation engine 104 may determine an amount of base colorant fluid at a region and determine the amount of auxiliary colorant fluid to print at the region based the reflective quality of the substrate and the amount of the base colorant fluid at the region, where a different region with a different amount of base colorant fluid is determined to receive a different amount of auxiliary colorant fluid.

The compensation engine 104 may operate as part of the processing pipeline for color calibration of an input image. For example, the compensation engine 104 may map an input color for a region of the input color image data to the amount of auxiliary colorant fluid using a color mapping resource, such as a table, based on the reflective quality of the substrate and the opacity grade of the base colorant. The compensation engine 104 may perform operations before the pipeline processing of an input image. For example, the compensation engine 104 may operate to identify the opacity grade of the base colorant fluid by making a request to a controller managing a supply of the base colorant fluid and/or may operate to identify the reflective quality of a substrate by making a request to a media catalog available as a cloud service.

The print engine 106 represents any circuitry or combination of circuitry and executable instructions to generate control instructions that, when executed, instruct the fluid ejection system to print the combination of the base colorant fluid and the auxiliary colorant fluid on the substrate to produce the target color. For example, the print engine 106 may be a combination of circuitry and executable instructions, that when executed, generate instructions to print an amount of auxiliary colorant fluid with a particular amount of base colorant fluid at a region of the substrate. The control instructions generated by the print engine 106 may instruct the fluid ejection system 102 to print a combination of the base colorant fluid and the auxiliary colorant fluid on the substrate during the same pass. For another example, such as in a multipass system, the control instructions generated by the print engine 106 may instruct the fluid ejection system 102 to print the base colorant fluid and the auxiliary colorant fluid during separate passes.

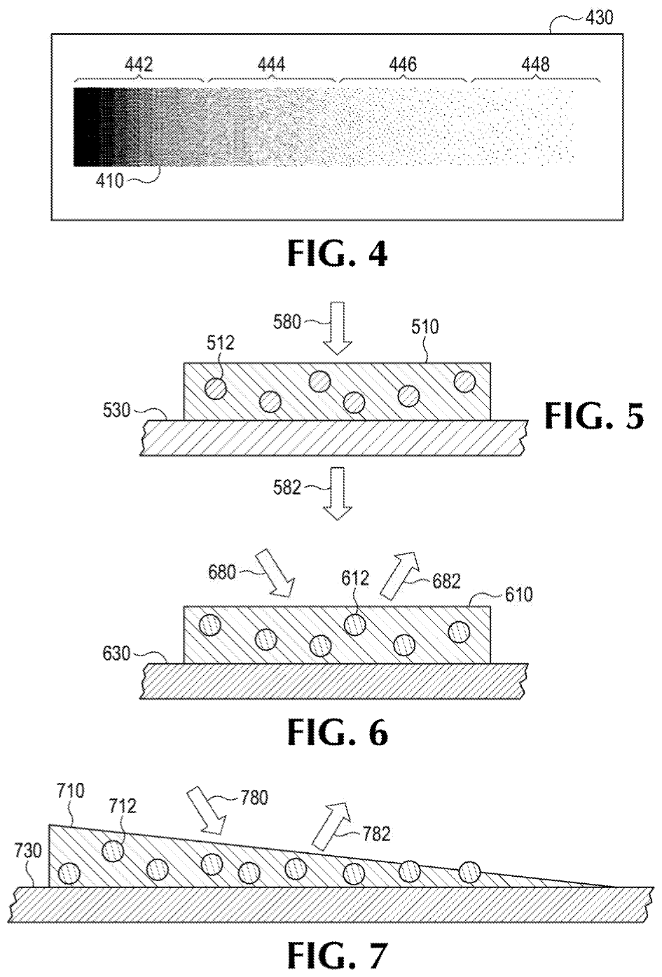

In some examples, functionalities described herein in relation to any of FIGS. 1-3 may be provided in combination with functionalities described herein in relation to any of FIGS. 4-11.

FIG. 2 depicts the example system 200 may comprise a memory resource 220 operatively coupled to a processor resource 222. Referring to FIG. 2, the memory resource 220 may contain a set of instructions that are executable by the processor resource 222. The set of instructions are operable to cause the processor resource 222 to perform operations of the system 200 when the set of instructions are executed by the processor resource 222. The set of instructions stored on the memory resource 220 may be represented as a compensation module 204 and a print module 206. The compensation module 204, and the print module 206 represent program instructions that when executed function as the compensation engine 104 and the print engine 106 of FIG. 1, respectively. The processor resource 222 may carry out a set of instructions to execute the modules 204, 206, and/or any other appropriate operations among and/or associated with the modules of the system 200. For example, the processor resource 222 may carry out a set of instructions to determine amounts of auxiliary colorant to print across a plurality of regions of a substrate to produce a target color across the plurality of regions based on a reflective quality of the substrate across the plurality of regions and an opacity grade of a base colorant across the plurality of regions and generate control instructions to operate a print apparatus to print a first amount of auxiliary colorant with the base colorant at a first region of the plurality of regions and print a second amount of auxiliary colorant with the base colorant at a second region of the plurality of regions to produce the target color across the plurality of regions. For another example, the processor resource 222 may carry out a set of instructions to retrieve a surface classification of the substrate, an expected viewing side of the substrate, and an expected illumination side of the substrate from a data structure representing a media profile corresponding to the substrate; determine the reflective quality of the substrate based on the surface classification of the substrate, the expected viewing side of the substrate, and the expected illumination side of the substrate; identify an auxiliary colorant color to compensate for an effect of the reflective quality of the substrate on the base colorant; determine amounts of auxiliary colorant to print across a plurality of regions of a substrate based on a reflective quality of the substrate and an opacity grade of a base colorant; and generate control instructions to operate a print apparatus to print the determined amounts of the base colorant and the auxiliary colorant across the regions accordingly.

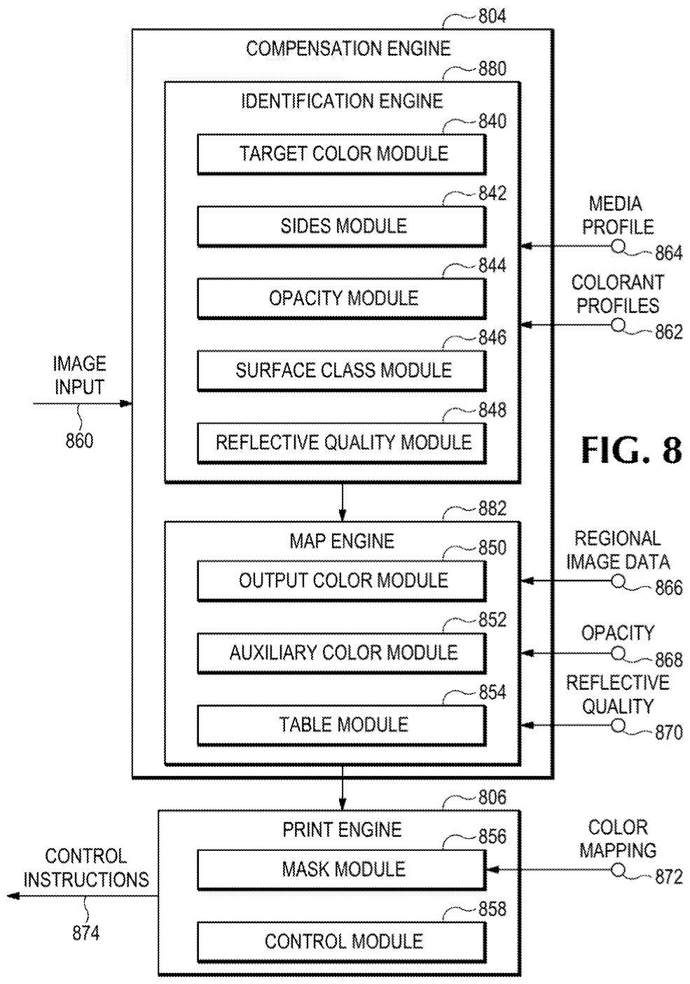

Although these particular modules and various other modules are illustrated and discussed in relation to FIG. 2 and other example implementations, other combinations or sub-combinations of modules may be included within other implementations. Said differently, although the modules illustrated in FIG. 2 and discussed in other example implementations perform specific functionalities in the examples discussed herein, these and other functionalities may be accomplished, implemented, or realized at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules. FIG. 8 depicts yet another example of how functionality may be organized into modules.

The processor resource 222 is any appropriate circuitry capable of processing (e.g., computing) instructions, such as one or multiple processing elements capable of retrieving instructions from the memory resource 220 and executing those instructions. For example, the processor resource 222 may be a central processing unit (CPU) that enables color balancing by fetching, decoding, and executing modules 204, and 206. Example processor resources include at least one CPU, a semiconductor-based microprocessor, a programmable logic device (PLD), and the like or any combination thereof. Example PLDs include an application specific integrated circuit (ASIC), a field-programmable gate array (FPGA), a programmable array logic (PAL), a complex programmable logic device (CPLD), and an erasable programmable logic device (EPLD). The processor resource 222 may include multiple processing elements that are integrated in a single device or distributed across devices. The processor resource 222 may process the instructions serially, concurrently, or in partial concurrence.

The memory resource 220 represents a medium to store data utilized and/or produced by the system 200. The medium is any non-transitory medium or combination of non-transitory media able to electronically store data, such as modules of the system 200 and/or data used by the system 200. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. The memory resource 220 may be said to store program instructions that when executed by the processor resource 222 cause the processor resource 222 to implement functionality of the system 200 of FIG. 2. The memory resource 220 may be integrated in the same device as the processor resource 222 or it may be separate but accessible to that device and the processor resource 222. The memory resource 220 may be distributed across devices.

In the discussion herein, the engines 104 and 106 of FIG. 1 and the modules 204 and 206 of FIG. 2 have been described as circuitry or a combination of circuitry and executable instructions. Such components may be implemented in a number of fashions. Looking at FIG. 2, the executable instructions may be processor-executable instructions, such as program instructions, stored on the memory resource 220, which is a tangible, non-transitory computer-readable storage medium, and the circuitry may be electronic circuitry, such as processor resource 222, for executing those instructions. The instructions residing on the memory resource 220 may comprise any set of instructions to be executed directly (such as machine code) or indirectly (such as a script) by the processor resource 222.

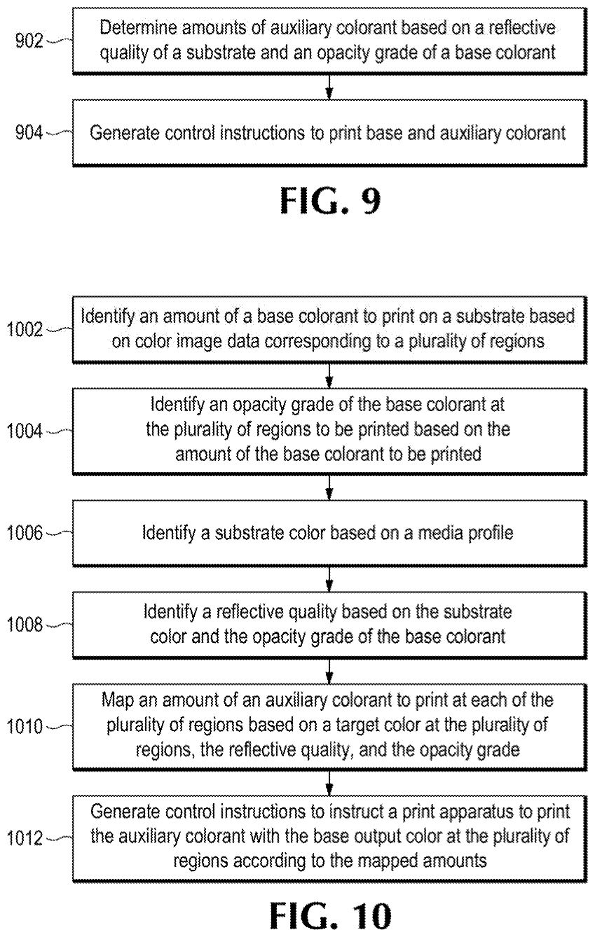

In some examples, the system 200 may include the executable instructions may be part of an installation package that when installed may be executed by the processor resource 222 to perform operations of the system 200, such as methods described with regards to FIGS. 9-11. In that example, the memory resource 220 may be a portable medium such as a compact disc, a digital video disc, a flash drive, or memory maintained by a computer device, such as a cloud server, from which the installation package may be downloaded and installed. In another example, the executable instructions may be part of an application or applications already installed. The memory resource 220 may be a non-volatile memory resource such as read only memory (ROM), a volatile memory resource such as random access memory (RAM), a storage device, or a combination thereof. Example forms of a memory resource 220 include static RAM (SRAM), dynamic RAM (DRAM), electrically erasable programmable ROM (EEPROM), flash memory, or the like. The memory resource 220 may include integrated memory such as a hard drive (HD), a solid state drive (SSD), or an optical drive.

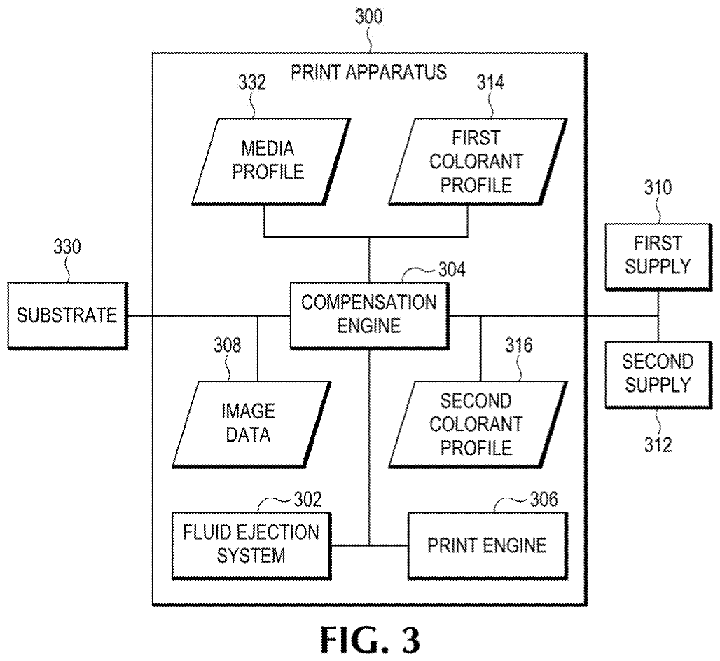

FIG. 3 depicts an example environment in which various example print systems may be implemented. The example print apparatus 300 is shown to include a fluid ejection system 302, a compensation engine 304, and a print engine 306. A substrate 330 is fed into the media holders of the print apparatus 300 and a first supply 310 of base colorant and a second supply 312 of auxiliary colorant are coupled to the print apparatus 300. FIG. 3 depicts that the compensation engine 304 utilizes data representations available to the system, including the original image data to be calibrated and printed by the print apparatus 300, the print fluid profiles 314 and 316 of the first colorant and the second colorant which are data structures containing data representing the print fluid attributes such as opacity grade, and the media profile 332 which is a data structure containing data representing the attributes of the media profile such as the substrate color and surface coating. The data used by the print apparatus 300 may be stored on a memory resource, such as memory resource 220, or multiple memory resources accessible by the print apparatus 300.

The print apparatus 300 (described herein with respect to FIGS. 1 and 2) may represent generally any circuitry or combination of circuitry and executable instructions to perform color calibration to compensate for the opacity grade of the base colorant and the reflective quality of the substrate on which the base colorant is applied. The fluid ejection system 302, the compensation engine 304, and the print engine 306, are the same as the fluid ejection system 102, the compensation engine 104, and the print engine 106 of FIG. 1, respectively, and the associated descriptions are not repeated for brevity. As shown in FIG. 3, the system 302 and the engines 304 and 306 may be integrated into a print apparatus 300, such as a wide format printer. The system 302 and the engines 304 and 306 may be integrated via circuitry or as installed instructions into a memory resource of the print apparatus 300. In another example, the compensation engine 304 and/or the print engine 306 may be located on a separate apparatus, such as a print server, that provides the control instructions to the print apparatus 300, as a cloud service, for example. For yet another example, the system 102 and engines 104 and of FIG. 1; the modules 204 and 206 of FIG. 2; and the system 302 and engines 304 and 306 of FIG. 3 may be distributed across devices. The engine and/or modules may complete or assist completion of operations performed in describing another engine and/or module. For example, the print engine 306 of FIG. 3 may request, complete, or perform the methods or operations described with the print engine 106 of FIG. 1 as well as the compensation engine 104 of FIG. 1. Thus, although the various engines and modules are shown as separate engines in FIGS. 1-3, in other implementations, the functionality of multiple engines and/or modules may be implemented as a single engine and/or module or divided in a variety of engines and/or modules. In some example, the engines of the print apparatus 300 may perform example methods described in connection with FIGS. 4-11.

FIGS. 4-7 depict example representations of printed material resulting from example print systems. Referring to FIG. 4, a pattern of a base colorant fluid 410 is printed across regions 442, 444, 446, and 448 of a substrate 430. The pattern of fluid 410 printed is different across the regions 442, 444, 446, and 448. In particular to FIG. 4, the pattern shows a gradual decrease of the amount of fluid deposited in each section from the left to right where there is a greater amount of base colorant fluid deposited in the left-most section 442 and a lesser amount of base colorant fluid deposited in the right-most section 448. Depending on the attributes of the substrate, the base colorant fluid may not appear substantially uniform across the regions 442, 444, 446, and 448. For example, if the substrate 430 has a black color and the base colorant fluid 410 has a white color, the gradual use of the base colorant fluid 410 may have a gradual increase of a bluish tint across the regions as more of the black substrate shows through. For another example, if the substrate 430 is a clear substrate with a yellow tint and the base colorant 410 is white, the white of regions 442 and 444 may appear to have a blue hue through the clear substrate 430 and the white of regions 446 and 448 may appear to have a yellowish hue through the clear substrate 430. Printed materials of example FIGS. 5-7 include some options to compensate for circumstances that generate a perceived change in hue.

FIGS. 5 and 6 depict drops 512 and 612 of auxiliary colorant fluid are placed in the same regions 510 and 610, respectively, of base colorant fluid to compensate for the perceived effect of the base colorant fluid in combination with the substrates 530 and 630. Referring to FIG. 5, arrow 580 depicts light from an illumination source entering the print and arrow 582 depicts light from the illumination source exiting the print. In this example, the substrate 530 has an illumination side from the top, printed side of the substrate and a viewing side from the bottom, non-printed side. This may be the case for printing on a clear, glass substrate, for example, where if the clear substrate has a yellowish tint, blue drops of auxiliary colorant fluid are added to a white layer of base colorant fluid to compensate for the yellow factor contributed by the substrate.

Referring to FIG. 6, arrow 680 depicts light from an illumination source onto a print and arrow 682 depicts light reflecting off the print. In this example, the substrate 630 has an illumination side and the viewing side on the same, top side of the print. This may be the case for printing on an opaque, paper substrate, for example, if the substrate has a bluish black color, yellow drops of auxiliary colorant fluid are added to a white layer of base colorant fluid to compensate for the bluish factor contributed by the substrate.

Referring to FIG. 7, a layer 710 of base colorant fluid may not be substantially uniform, such as in the example of FIG. 4. Because the effect of the substrate 730 and/or lighting environment (as shown by arrows 780 and 782 may not be substantially uniform due to the amount of base colorant across the region, an amount of auxiliary colorant fluid that is proportional to the amount of base colorant fluid is added to the layer 710 as represented by drops 712. A compensation engine may identify a difference between an input color and the base colorant at a region of the substrate and determine an amount of auxiliary colorant to print at the region based on the difference and a layer characteristic of a layer of the base colorant at the region. For example, a layer characteristic may be a concentration of pigment of the base colorant fluid. For another example with reference to FIG. 7, the layer characteristic may be an expected thickness of the base colorant at the region, such as the change in thickness from the left-most side of the region depicted in FIG. 7 to the right-most side of the region depicted in FIG. 7. In that example, the compensation engine determines that, across regions, there is a first amount of base colorant at a first region that is different from a neighboring, second amount of base colorant; determines amounts of auxiliary colorant to print at the regions that vary according to the variation in amount of base colorant (as well as any other factors discussed herein, such as the reflective quality of the substrate, the opacity grade of the base colorant, the expected viewing side of the substrate, the expected illuminated side of the substrate, an expected amount of illumination from an illumination source, a color of light expected to be produced by the illumination source); and a print engine generates control instructions to instruct the print apparatus to print the identified amounts of base colorant and the determined amounts of auxiliary colorant so that the fluid ejection system that operates the control instructions prints a substantially uniform hue of a target color across the regions on the substrate.

The effect of the viewing environment may vary across the print, which may affect the amount of auxiliary colorant fluid determined by a compensation engine, for example. For example, the percentage of auxiliary colorant per base colorant to change across the plurality of regions may be based on the opacity grade of the base colorant, differences in the amount of base colorant across the plurality of regions, and the background color of the substrate. For another example, a print engine may identify a subset of pixels of a region to print the auxiliary colorant and the number of pixels of the subset of pixels to print the auxiliary colorant, as determined by the compensation engine, inversely changes across regions with respect to an amount of base colorant to be printed across the regions. The print system may be implemented into subsystems to identify the attributes of the print fluid, substrate, and presenting environment and/or analyze factors contributed by those attributes. One example of such subsystems is described with reference to FIG. 8.

FIG. 8 depicts example modules used to implement an example print system. Referring to FIG. 8, the example modules of FIG. 8 generally includes a print engine 806 and a compensation engine 804 that are similar to the print engine 306 and the compensation engine 304 of FIG. 3. The compensation engine 804 includes an identification module 880 for identifying the perception factors for compensation and a map engine 882 to adjust the color mapping in accordance with the effect of the identified perception factors. The example engines and modules of FIG. 8 may be implemented on a compute device, such as print apparatus with an integrated fluid ejection system or a print server for offloadable job processing.

Input image data 860 is received by the compensation engine 804. The compensation engine 804 activates the identification engine 880 to retrieve a media profile 864 associated with the media available to the print system and colorant profiles 862 associated with the print fluid supplies available to the print system. The identification engine 840 includes a target module 840, a sides module 842, an opacity module 844, a surface class module 846, and a reflective quality module 848. The target color module 840 represents program instructions that, upon execution, cause a processor to identify a target color for a region of the input image. A target color may be a combination of colored inks available on a print apparatus, where the combination produces a perceived color corresponding to the color at the particular region of the input image. The sides module 842 represents program instructions that, upon execution, cause a processor to identify the illumination side of the substrate with reference to the print and a viewing side of the substrate with reference to the print. The opacity module 844 represents program instructions that, upon execution, cause a processor to identify the opacity grade of a base colorant fluid (e.g., the print fluid(s) used to produce the target color). The surface class module 846 represents program instructions that, upon execution, cause a processor to identify a type of surface of the substrate to be printed on, such as a glossy or matte finished paper or a transparent plastic substrate. The reflective quality module 848 represents program instructions that, upon execution, cause a processor to identify a reflective quality 870 based on the surface class of the substrate, the opacity grade of the base colorant fluid, the illumination side, and the viewing side of the substrate. The attributes identified by the identification engine 840 may be determined by calculation, table look-up, and/or retrieved from information provided with the print job.

The map engine 882 includes an output color module 850, an auxiliary color module 852, and a table module 854. The output color module 850 represents program instructions that, upon execution, cause a processor to identify an output color at a region based on the regional image data and the reflective quality 870. The auxiliary color module 852 represents program instructions that, upon execution, cause a processor to identify a difference between the target color at a region and the output color at the region and select an auxiliary color corresponding to the identified difference. The table module 854 represents program instructions that, upon execution, cause a processor to determine the amount of the selected auxiliary color to compensate for the difference between the target color and the output color using a table that utilizes the factors of the print job, including the opacity grade 868 of the base colorant fluid and the reflective quality 870 of the substrate to be printed on.

The determined amount of auxiliary print fluid is provided to the print engine 806 to generate appropriate control instructions as part of a color mapping 872. The print engine 806 of FIG. 8 includes a mask module 856 and a control module 858. The mask module 856 represents program instructions that, upon execution, cause a processor to identify a halftone mask to represent printing the amount of auxiliary print fluid with the base colorant at each region. The control module 858 represents program instructions that, upon execution, cause a processor to generate printer-specific control instructions to produce the halftone mask identified by the mask module 858 using the color mapping 872 with the compensatory amount of auxiliary fluid identified by the compensation engine 804. The print engine 806 provides the control instructions to the print apparatus to operate the print apparatus to produce the input image on the substrate with compensation for attributes of the print job (including the attributes of the substrate and the attributes of the presentation environment).

FIGS. 9-11 are flow diagrams depicting example methods of color balancing. The blocks of the methods of color balancing of FIG. 9-11 are performable by the appropriate engines discussed herein with reference to FIGS. 1-8. Referring to FIG. 9 example methods for color balancing may generally comprise determining amounts of auxiliary colorant based on a reflective quality of a substrate and an opacity grade of a base colorant and generating control instructions to print the base and auxiliary colorants. For example, whenever an identifiable effect of a print substrate color on perceived color is identified, an amount of auxiliary ink is identified with a color to compensate for the identifiable effect and included with the control instructions to produce the print (e.g., the control instructions are modified to include the additional auxiliary amount with respect to the original image input).

Referring to FIG. 10, an example method of color balancing generally comprises identifying the attributes of the print job that may create color perception issues, mapping the identified factors to an amount of auxiliary colorant fluid to compensate for the color perception issues, and generating control instructions to print with the auxiliary colorant fluid to compensate for the color perception issues.

At block 1002, an amount of a base colorant to print at a plurality of regions on a substrate is identified based on color image data corresponding to the plurality of regions. For example, a white color for a region may be identified and amount of white base colorant to print at the corresponding region of the substrate is identified. In another example, a gradual white fade may be identified for placement across a plurality of regions and an amount of white base colorant to print across the corresponding regions of the substrate may be identified.

At block 1004, an opacity grade of the base colorant at the plurality of regions of a substrate to be printed is identified based on the amount of the base colorant to be printed at the plurality of regions. For example, the amount of base colorant may be a substantially uniform amount across the plurality of regions or a non-uniform amount, such as with the example of FIG. 7. The opacity grade may be related to the amount of base colorant or may be independent to the amount of base colorant.

At block 1006, a substrate color is identified based on a media profile corresponding to the substrate to be printed on. The substrate color is the color of the substrate and, for examples, may be the background color or the foreground color depending on whether the print is to be seen on top of the substrate or seen through the substrate, such as an image printed on clear glass. The type of media is accessible when loaded into a print apparatus or may be manually entered into the user interface of a print apparatus. For example, the class of media may be provided with the print job information. A reflective quality is identified at block 1008 based on the substrate color and the opacity grade of the base colorant at the plurality of regions. The identification of the reflective quality may also take into consideration other factors mentioned herein, such as the illumination factors and viewing side of the print, which may also be provided with the print job information.

At block 1010, an amount of an auxiliary colorant to print at each of the plurality of regions is mapped based on a target color at the plurality of regions, the reflective quality at the plurality of regions, and the opacity grade of the base colorant at the plurality of regions. For example, a table may be used where a target color, reflective quality, and an opacity grade are used to locate a particular amount of auxiliary colorant fluid to compensate for the reflective quality. The result of the mapping is processed and control instructions to instruct a print apparatus to print the auxiliary colorant with the base output color at the plurality of regions is generated according to the mapped amounts.

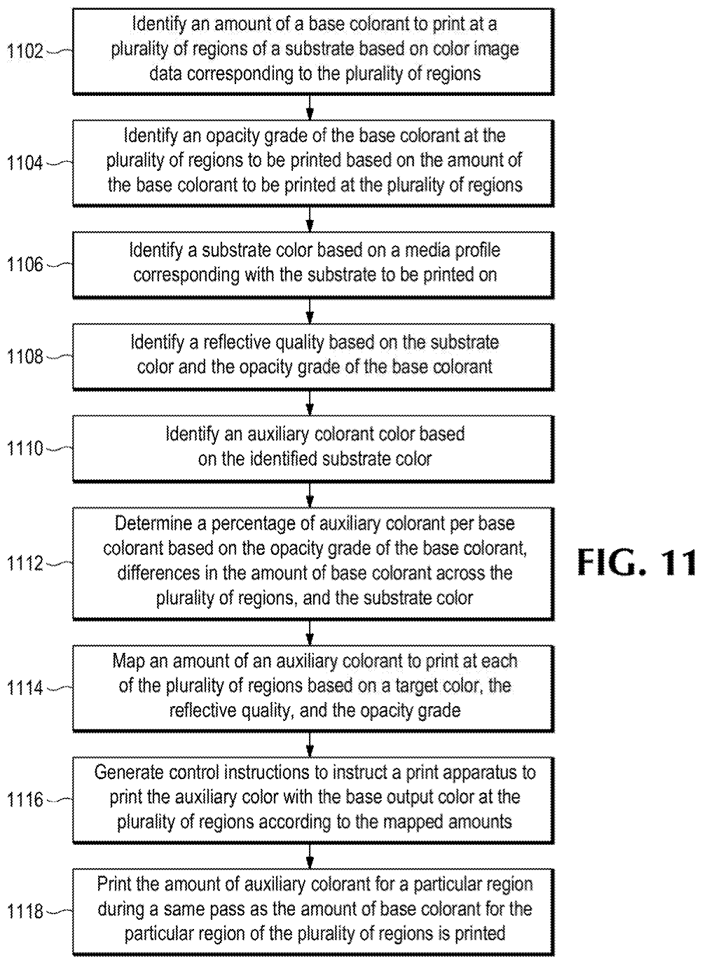

FIG. 11 includes blocks similar to blocks of FIG. 10 and provides additional blocks and details. In particular, FIG. 11 depicts additional blocks and details generally regarding determining an auxiliary colorant color, determining a percentage of auxiliary colorant per base colorant, and printing the auxiliary colorant and the base colorant during the same pass. Blocks 1102, 1104, 1106, 1108, 1114, and 1116 are similar to blocks 1002, 1004, 1006, 1008, 1010, and 1012 of FIG. 10 and, for brevity, their respective descriptions are not repeated.

At block 1110, an auxiliary colorant color is identified based on the identified substrate color. For example, a resultant color produced by the combination of the base colorant and the substrate color may be determined and an opposing color to the resultant color may be determined to be used as the auxiliary colorant color to compensate for the difference between the resultant color and a target color for a particular region.

At block 1112, a percentage of auxiliary colorant per base colorant is determined. For example, an effect of the reflective quality on the base colorant may be converted to a compensatory amount of auxiliary color per amount of base colorant and thus the amount of auxiliary colorant changes proportionally with changes to the amount of base colorant printed at each region. For another example, the percentage of auxiliary colorant per base colorant may change across the plurality of regions based on the opacity grade of the base colorant, differences in the amount of base colorant across the plurality of regions, and the background color of the substrate.

At block 1118, the amount of auxiliary colorant for a particular region is printed during the same pass as the amount of base colorant for the particular region of the plurality of regions is printed in response to execution of the generated control instructions. For example, the control instructions may be generated from that a halftone mask of base colorant and auxiliary colorant and, upon execution of the control instructions by a print apparatus, the print apparatus prints the complementary mask for each colorant via the plurality of print heads.

Although the flow diagrams of FIGS. 8-11 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present description.

All of the features disclosed in this specification (including any accompanying claims, abstract and drawings), and/or all of the elements of any method or process so disclosed, may be combined in any combination, except combinations where at least some of such features and/or elements are mutually exclusive.

The present description has been shown and described with reference to the foregoing examples. It is understood, however, that other forms, details, and examples may be made without departing from the spirit and scope of the following claims. The use of the words “first,” “second,” or related terms in the claims are not used to limit the claim elements to an order or location, but are merely used to distinguish separate claim elements.

What is claimed is:

1. A print apparatus comprising:
a fluid ejection system comprising:
a first print head to print a base colorant fluid; and
a second print head to print an auxiliary colorant fluid;
a compensation engine to determine an amount of the auxiliary colorant fluid to produce a combination of the base colorant fluid and the auxiliary colorant fluid based on input color image data, a reflective quality of a substrate to be printed on, and an opacity grade of the base colorant fluid; and
a print engine to generate control instructions that, when executed, instruct the fluid ejection system to print the combination of the base colorant fluid and the auxiliary colorant fluid on the substrate.

2. The apparatus of claim 1, wherein:
the compensation engine maps an input color for a region of the input color image data to the amount of auxiliary colorant fluid using a color mapping resource based on the reflective quality of the substrate and the opacity grade of the base colorant fluid.

3. The apparatus of claim 1, wherein:
the compensation engine determines an output color represented by the amount of auxiliary colorant fluid and a complementary amount of base colorant fluid to compensate for the reflective quality of the substrate as perceived across a region of the substrate through the complementary amount of base colorant fluid.

4. The apparatus of claim 1, wherein the compensation engine:
determines an amount of the base colorant fluid at a region; and
determines the amount of the auxiliary colorant fluid to print at the region based on the amount of the base colorant fluid at the region and the reflective quality of the substrate.

5. The apparatus of claim 1, wherein the compensation engine:
identifies a difference between an input color and the base colorant at a region of the substrate; and
determines the amount of auxiliary colorant fluid to print at the region based on the difference and a layer characteristic of a layer of the base colorant fluid at the region.

6. The apparatus of claim 5, wherein:
the layer characteristic is an expected thickness of the base colorant fluid at the region; and
the difference between the input color and the base colorant fluid includes a user-provided adjustment to an output color producible by the combination of base colorant fluid and the auxiliary colorant fluid.

7. The apparatus of claim 1, wherein:
the print engine identifies a subset of pixels of a region to print the auxiliary colorant, the number of pixels of the subset of pixels inversely changes across regions with respect to an amount of base colorant to be printed across the regions.

8. The apparatus of claim 1, wherein:
the compensation engine is to:
identify the opacity grade of the base colorant; and
identify the reflective quality of the substrate,
wherein the control instructions, when executed, instruct the fluid ejection system to print the combination of the base colorant fluid and the auxiliary colorant fluid on the substrate by printing the amount of auxiliary colorant fluid and a complementary amount of the base colorant fluid during the same pass of the fluid ejection system over the substrate.

9. The apparatus of claim 1, wherein:
the compensation engine determines the amount of auxiliary colorant fluid based on an expected viewing side of a resultant print on the substrate and an expected illuminated side of the resultant print on the substrate; and
the print apparatus includes user interface with a slider for the user to make adjustments to an output color to be produced by the combination of base colorant fluid and auxiliary colorant fluid.

10. A non-transitory computer-readable storage medium comprising a set of instructions executable by a processor resource to:
determine amounts of auxiliary colorant to print across a plurality of regions of a substrate to produce a target color across the plurality of regions based on a reflective quality of the substrate across the plurality of regions and an opacity grade of a base colorant across the plurality of regions; and
generate control instructions to operate a print apparatus to print a first amount of auxiliary colorant with the base colorant at a first region of the plurality of regions and print a second amount of auxiliary colorant with the base colorant at a second region of the plurality of regions to produce the target color across the plurality of regions, wherein the first amount of auxiliary colorant and the second amount of auxiliary colorant are different.

11. A medium of claim 10, wherein the set of instructions are executable by the processor resource to:
retrieve a surface classification of the substrate, an expected viewing side of the substrate, and an expected illumination side of the substrate from a data structure representing a media profile corresponding to the substrate;
determine the reflective quality of the substrate based on the surface classification of the substrate, the expected viewing side of the substrate, and the expected illumination side of the substrate; and
identify an auxiliary colorant color to compensate for an effect of the reflective quality of the substrate on the base colorant.

12. The medium of claim 11, wherein:
the control instructions instruct the print apparatus to print a first amount of base colorant at the first region and a second amount of base colorant at the second region;
the first amount of base colorant and the second amount of base colorant are different; and
wherein the amounts of auxiliary colorant to print at each of the plurality of regions are determined based on the reflective quality of the substrate, the opacity grade of the base colorant, the expected viewing side of the substrate, the expected illuminated side of the substrate, an expected amount of illumination from an illumination source, a color of light expected to be produced by the illumination source, and the amount of base colorant at each of the plurality of regions to generate a substantially uniform hue of the target color across the plurality of regions.

13. A method of color balancing, comprising:
identifying an amount of a base colorant to print at a plurality of regions of a substrate based on color image data corresponding to the plurality of regions;
identifying an opacity grade of the base colorant at the plurality of regions to be printed based on the amount of the base colorant to be printed at the plurality of regions;
identifying a substrate color based on a media profile corresponding with the substrate to be printed on;
identifying a reflective quality based on the substrate color and the opacity grade of the base colorant at the plurality of regions;
mapping an amount of an auxiliary colorant to print at each of the plurality of regions based on a target color at the plurality of regions, the reflective quality at the plurality of regions, and the opacity grade of the base colorant at the plurality of regions; and
generating control instructions to instruct a print apparatus to print the auxiliary color with the base output color at the plurality of regions according to the mapped amounts.

14. The method of claim 13, comprising:
identifying an auxiliary colorant color based on the identified substrate color; and
determining a percentage of auxiliary colorant per base colorant, the percentage of auxiliary colorant per base colorant to change across the plurality of regions based on the opacity grade of the base colorant, differences in the amount of base colorant across the plurality of regions, and the substrate color.

15. The method of claim 14, comprising:
printing, in response to execution of the generated control instructions, the amount of auxiliary colorant for a particular region during a same pass as the amount of base colorant for the particular region of the plurality of regions is printed.
